(19) United States
(12) Patent Application Publication
(10) Pub. No.: US 2015/0321165 A1
(43) Pub. Date: Nov. 12, 2015

(54) Carbon chain polymerization of coal combustion emissions

(71) Applicant: Edward Milton McWhorter, Citrus Heights, CA (US)

(72) Inventor: Edward Milton McWhorter, Citrus Heights, CA (US)

(73) Assignee: Edward Milton McWhorter, Citrus Heights, CA (US)

(21) Appl. No.: 14/120,245

(22) Filed: May 12, 2014

(51) Int. Cl. B01J 19/08

(52) U.S. Cl. CPC B01J 19/088; B01J 2219/12

(57) ABSTRACT

An electrochemical procedure for the synthesis of carbon chain polymers from coal combustion emissions is presented. A coulostatic current surge is electrochemically generated at 1 second intervals by oxidation of finite quantities of reduced alkaline metal electrolytic fuels. The oxidation procedure occurs within a flowing circuit of heated CO₂ carrier gas. Electrons (e⁻) and protons (H⁺) are formed in the immediate presence of contiguous CO₂ molecules. The protons (H⁺) formed become lodged within the structural interstice of the CO₂ molecules forming positive charged electrophilic univalent aldehydes (CO₂H⁺) are brought together again between negative charged plates of an anodal stabilization chamber to form specific carbon chain polymers at specific converging harmonic frequencies.

### BACKGROUND OF THE INVENTION

The invention is an anodal stabilization chamber which is the final process of a five step electrochemical procedure for the organic synthesis of carbon chain polymers and for tertiary nitrile products from coal fired furnace emissions. In the beginning process an intensive electrical surge is released at one second evenly spaced intervals by dispensing finite quantities of sodium into a water spray within a reaction chamber. The hydrolyzation produces a coulombic surge within the interstice of a heated CO₂ molecules carrier gas flowing continuously through the reaction chamber. In the present application one pound (1 lb) of sodium is divided into 3600 finite 126 mg quantities to synthesize 6000 pounds of heated CO₂ per hour into carbon chain products.

The electrical energy required in the synthesis procedure is obtained by the oxidation of reduced alkaline metals (Li, Na, K) and alkaline earth metals (Mg, Ca). These metals are hereinafter referred to as “electrolytic fuels”. The oxidation of 1 lb of Na by hydrolyzation shown in Eq. 1 produces 528 ampere-hours of electrical current.

$$Amp \text{-} hours 1 lb = \frac{Coulombs \times grams}{Na eq . wt \times seconds} = \frac{96.500 \times 453.59}{22.99 \times 3600} = 528 amp \text{-} hrs \text{/} lb \qquad Eq . 1$$

The electrical energy in a reduced metal is stored as an electrochemical potential equivalence which is equal to its oxidative release after hydrolyzation. Hydration of 126 mg/sec of sodium produces an electrical current surge of 30 coulombs/sec.

126 mg Na+H—OH→NaOH+H⁺+e⁻→30.00 coulombs Eq. 2

The 30 coulombs of Eq. 2 is released at one second (1 sec) evenly spaced intervals of peaked oscillative modular flow hereinafter referred to as a “coulombic surge”. The hydration of 126 mg of sodium also produces 2.72×10¹⁹ electrons (e⁻) and an equal number of much heavier companion protons (H⁺) which are released into the flowing heated CO₂ carrier gas stream.

Sodium is chosen in the demonstration example presented because it is the least expensive of the alkaline metals which are to be used in the process and it is important to note; Sodium is 33 times more abundant in the earth's crust than the total sum of all fossil fuels (petroleum, coal, natural gas). Alkaline metal electrolytic fuels are also used in the battery circuits of domestic electric cars. The cost of hydroelectric generated sodium based electrolytic fuel is about $0.50/lb. Wind and solar generated sodium electrolytic fuels will cost about $1.00/lb. The availability of electrolytic fuels (Li, Na, K, Ca, Mg) are 129 times more plentiful in the earth's crust than carbon based fossil fuels (petroleum, coal, natural gas) as shown graphically in FIG. 1 of the drawings.

The protons (H+) released in the hydrolyzation reaction of Eq. 2 are distributed within the thermally expanded interstices of the heated CO₂ molecules of the carrier gas while the electrons (e⁻) simultaneously produced in Eq. 2 move freely within the gaseous diffuse mixture of diverse elements, NaOH, CO₂, e⁻, H⁺ flowing through the reaction chamber. The NaOH component is removed in intermediate secondary reactions in the formation of sodium carbonate (Na₂CO₃.nH₂O). The sodium carbonate (N₂CO₃) is inert and has no further effect within the reacting system and is removed as a precipitant.

The synthesis procedure presented begins as a coulombic surge generated by the hydration of finite 126 mg quantities of sodium at one second evenly spaced intervals. The hydration of the sodium occurs within a heated CO₂ carrier gas flowing through a reaction chamber at 6000 lbs per hour. The hydrolyzation reaction produces 30 amperes per second releasing 2.72×10¹⁹ electrons (e⁻) and an equal number of companion protons (H⁺) as indicated in Eq. 2. The diffuse mixture of hydrolyzation reaction components is carried out of the reaction chamber by heated CO₂ carrier gas and passes into a steel cylinder that is flanged at both ends and has an evenly spaced plurality of finned protrusions longitudinally lining its inner surface. The steel chamber is called a “tuyere” and the finned protrusions are called “strakes”. The negative electron charges (e⁻) of Eq. 2 are produced within the heated CO₂ carrier gas and are electrostatically absorbed on the strakes lining the internal surface of the tuyere. The electrons electrostatically absorbed on the tuyere strakes are transferred by electrical conduction into a dielectric capacitor circuit. The tuyere strakes and dielectric capacitor circuit function in unison and are hereinafter referred to as a “capacitor tuyere”. The capacitor tuyere is used to produce free electron charges (e⁻) for electrical generation and also for the simultaneous production of open bonded univalent aldehydes (CO₂⁻H⁺) in the present application for commercial production of carbon chain polymers. The much heavier companion protons (H⁺) of Eq. 2 remain lodged within the interstice structure of the heated CO₂ carrier gas and pass out of the capacitor tuyere through a subsonic expansion nozzle into a ceramic alignment chamber. The expansion of the diffuse mixture increases molecular polar moment of the heated CO₂ carrier gas molecules and increases the mean free path of system associated particles producing stronger resonance at maximum ultrasonic absorbance at 20 kc/sec improving the opportunity for entach juxtaposition on entrance into the anodal stabilization chamber for polymerization. Nozzle expansion is also a cooling process which increases the heated CO₂ carrier gas molecular interacting bonding strength thus tightening the hold on the proton (H⁺) lodged within the interstices forming unstable univalent aldehydes (CO₂H⁺). The alignment of the univalent aldehydes entering the alignment chamber decreases the steric hindrance (bulk interference) of the univalent aldehyde structure allowing it to resonate more intensely at the 20 kc ultrasonic frequency and to incidentally respond to corresponding harmonic terahertz modulating carbon chain chopping frequencies, within the harmonic quantum frequency of the commercial product.

The electrons (e⁻) and protons (H⁺) of Eq. 2 that were separated in the tuyere, pass out of the capacitor tuyere on separate circuits and enter the alignment chamber. The electrons (e⁻) pass into the diactinic induction coil positioned over the outer surfaces of the ceramic cylinder of the alignment chamber. The protons (H⁺) remain in the ionic state enmeshed unstable within the fluidic interstice of the heated CO₂ carrier gas and flow into the interior ceramic tubular structure of the alignment chamber.

The diactinic induction coil is formed in an undulative pattern of eight intermediate semi-elliptical bent wire divisions forming a singular circular winding pattern of the induction coil comprising a plurality of such windings.

The diatinic coil radiates two kinds of electron negative charge fields—spherical plenary fields and oblate divisional fields. When the electrons (e⁻) approach the juncture between elliptical segments of the coil winding they begin to lose momentum at the higher resistance of the sharper turning curve and become more closely compact. The like-on-like negative charge spherical fields become oblate on continued compaction. At critical compaction, which occurs at the highest point of coulombic surge of Eq. 2, the negative oblate field cannot follow the spin of the parent electrons and are ejected through the ceramic wall of the alignment chamber and are attracted toward the electrophilic univalent aldehyde (CO₂H⁺) and this attractive force weakens the double bonds of the oxygen molecule. During the anodal stabilization process these weakened bonds are severed to form single bond (0-0) which is the weakest bond of all organic bonding energies (33.1 kcal/mole) releasing oxygen into the gaseous product stream of the anodal stabilization chamber. In the alignment process only the critical oblate negative electron field penetrate the ceramic wall of the alignment chamber. The electrons (e⁻) continue in conduction to pass out of the diactinic coil and pass into the anodal stabilization chamber magnetic siphon coil.

Electrons (e⁻) and protons (H⁺) of Eq. 2 that were separated in the capacitor tuyere and passed into the alignment chamber on separate paths are brought together again within the electrostatic field between negative charged metal plates of the anode electrode assembly of the anodal stabilization chamber. The union of the electron (e⁻) to the proton (H⁺) occurs in the direction in which the heavier proton (H⁺) lodged within the heated carrier gas molecule forming a univalent aldehyde (CO₂H⁺). The mass of proton (H⁺) is 1836 times heavier than the electron (e⁻) which is nearly weightless weighing only (9.109×19⁻³¹ kg). The heated CO₂ carrier gas is drawn into the space between the negative charged anode plates by a water aspirator assembly tube. The diffuse moisture between the negative charged anodal plates acts as a class 2 conductor carrying the electrons (e⁻) into the carrier gas releasing the protons (H⁺). The released protons strengthen the dielectric properties of the water to form H₃ and reactive CO₂ as shown in Eq. 3.

CO₂H⁺+H₂O→CO₂+H₃O Eq. 3

The 1^{st} terahertz harmonic modulation frequency beating against the 20 kc ultrasonic carrier frequency has sufficient kinetic energy to bring contiguous carbon atoms closer together at modulated harmonic incidence to form electrostatic negative charge between the anodal plates to react the activated CO₂ molecule with the H₃O molecules of Eq. 3 to produce a carbohydrate molecule.

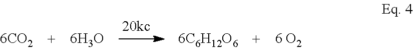

The products formed as shown in Eq. 4 are carbohydrates and oxygen.

### SUMMARY OF THE INVENTION

An Electrochemical procedure for the manufacture of carbon chain polymers from carbon dioxide emissions of coal-fired furnaces is presented.

### BRIEF DESCRIPTION OF THE DRAWINGS

Seven drawings of the invention are presented to illustrate the synthesis procedure. Drawing FIGS. 1, 2, and 3 are informational drawings relating to the procedure. Drawings 4, 6,7 relate directly to mechanical details claimed.

FIG. 1 graphically represents the availability of the alkaline metal electrolytic fuels to carbon based fossil fuels for electrical processing though out the procedure.

FIG. 2 is a graphical chart listing the electrochemical equivalent energy stored in alkaline metal electrolytic fuels claimed in the procedure.

FIG. 3 illustrates the sequential order of the five processes used sequentially in the synthesis procedure.

FIG. 4 is an anodal stabilization disc plate shown in partial section.

FIG. 5 is an anodal stabilization chamber electrode assembly shown in partial section.

FIG. 6 is an assembly of the alignment chamber and anodal stabilization chamber shown in section.

FIG. 7 is a side-view of the anodal stabilization chamber shown in section.

### DETAILED DESCRIPTION OF THE INVENTION

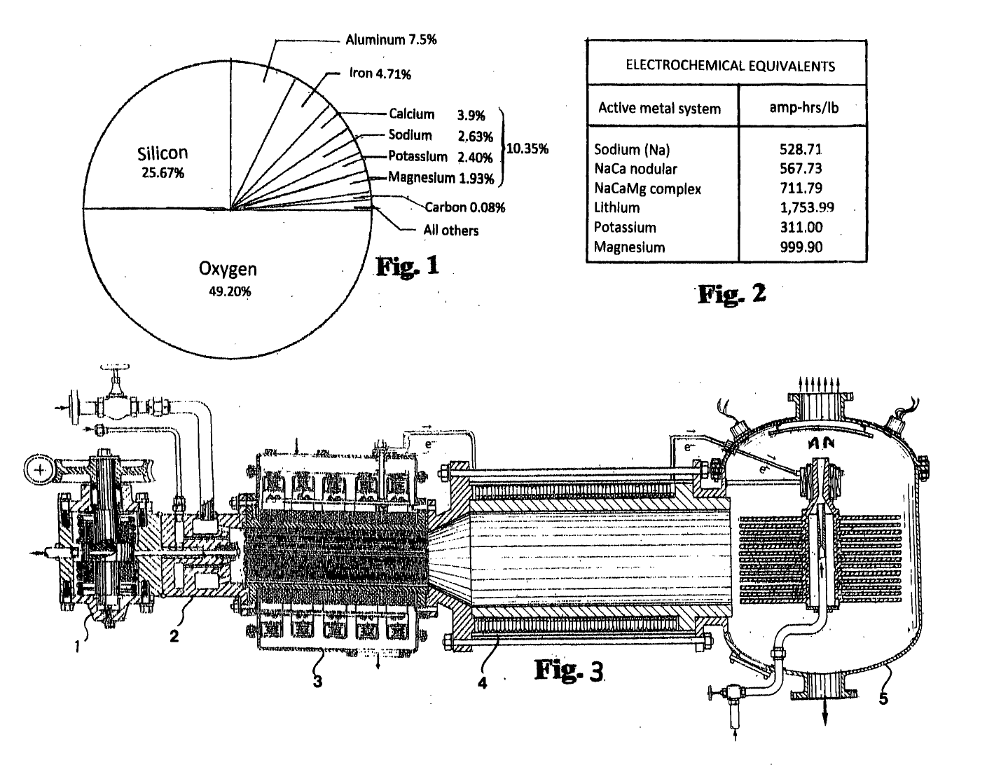

An electrochemical procedure is used in commercial manufacture of carbon chain polymers and tertiary nitrile products from coal combustion emissions. Electrolytic fuels are used in the procedure for the generation of electric energy instead of steam generated electricity by fossil fuels. The electrolytic fuel used in the example presented in the present application is sodium. FIG. 1 indicates that sodium used as an example in the process is more plentiful than fossil fuel. FIG. 1 indicates that electrolytic sodium is 129 times (10.35/08=129) more plentiful than the combined sum of all the carbonaceous fuels, petroleum, coal and natural gas.

FIG. 2 is a tabular list of the electrolytic fuels that are used in the electrochemical procedure claimed. FIG. 2 indicates the storability and coulombic energy release given in amp-hrs/lb. FIG. 2 also indicates that one pound of sodium is capable of storing and delivering 528 amp-hours. One pound of hydroelectric sodium costs $0.50/lb and in electric car battery use and is capable of replacing 20 gallons of gasoline in the replacement of fossil fuels for internal combustion engines. Gasoline costs about $4.00/gal and in respective usage (20×$4.00/lb=$80.00 or about 160 times more expensive than electrolytic fuel.

FIG. 3 is a graphical overview of the sequential order of the five interacting processing components and illustrates the manner of separate mechanical electrical attachment. The first process of the procedure is a simplex valving circuit 1 which function as a fluid control system used in dispensing small finite quantities of electrolytic fuels into injector circuit 2. The said finite quantities of electrolytic fuel passes through a water spray in injector 2 and is hydrolyzed forming electrons (e⁻) and protons (H⁺) by exothermic chemical reaction within a heated CO₂ carrier gas that is also flowing into the injector 2.

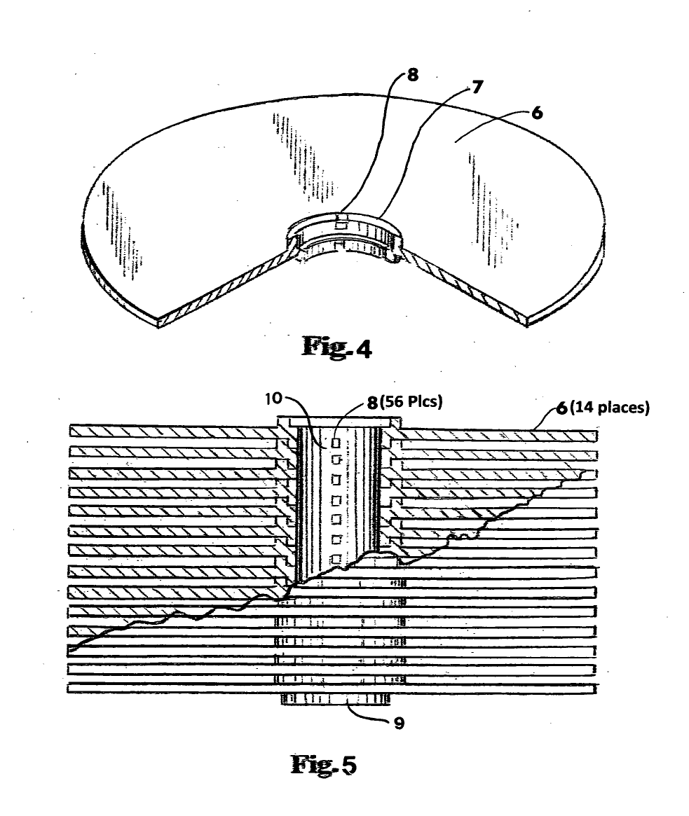

Turning now to FIG. 4 which is an isometric view of an anode disc plate 6, comprising a top and bottom interlocking assembly collar 7, having 4 aspirating matched orifices on each said top and bottom portions of collar 7. Fourteen plates 6 will be stacked and held in place by their interlock collars to form an anode electrode assembly shown in FIG. 5.

FIG. 5 is a side view of an anode element 9 assembly. The anode electrode element 9 assembly is assembled by stacking plates 6 using interlocking collars 7. The spacing between discs plates 6 are electromeric transfer surfaces used to stabilize the univalent aldehyde (CO₂H⁺) in removing oxygen in the transfer mechanism as shown in Eq. 3 and Eq. 4. Aspiration orifices 8 on the said top and bottom interlocking collar 7 are positioned by matching alignment and the assembly is furnace brazed forming a central passage of an aspiration tube 10 which by aspiration of the diffuse mixture of univalent aldehyde (CO₂H⁺) flowing out of alignment chamber 12 are conveyed across the negative charged plate 6 surfaces producing carbon chains in the electromeric transfer of electrons to the positive charged proton (H⁺) releasing oxygen molecules.

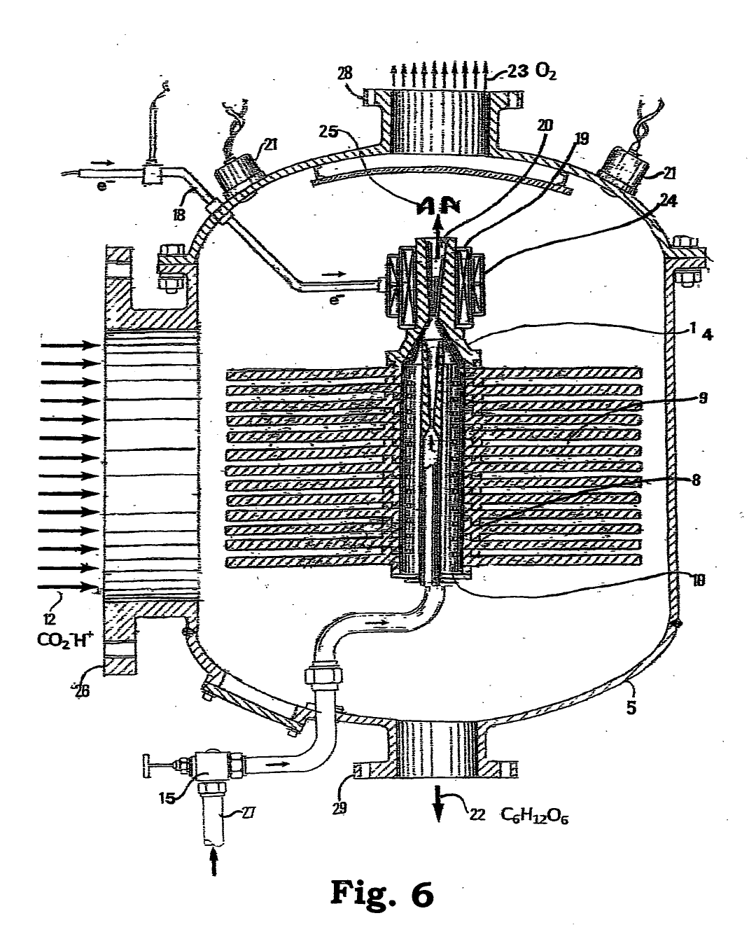

Turning now to FIG. 6 which shows the alignment chamber 4 attached to anodal chamber 5 at flange 26. Heated CO₂ carrier gas and protons (H⁺) formed in Eq. 2 enter alignment chamber 4 through expansion nozzle 13 as univalent aldehyde 12 (CO₂H⁺) and are polar aligned magnetically into a uniform orientation (juxtapositioned) for more entach union with electrons (e⁻) flowing between plates 6 of anodal assembly 9 electrons (e⁻).

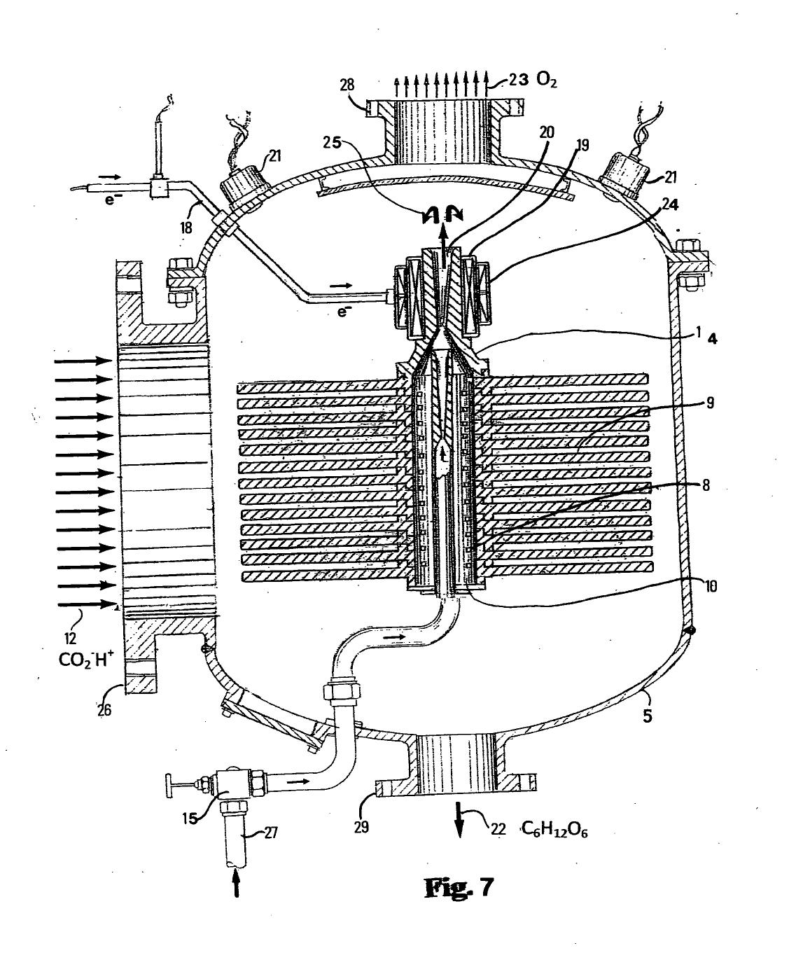

Turning now to FIG. 7 which is a side-view of the anodal stabilization chamber shown in section. The anodal chamber is the final process component of the five part procedure for the synthesis of carbon chains from coal CO₂ combustion emissions. One ton of coal produces three tons (6,000 lbs) of CO₂ emissions. The three tons of coal (6000 lbs) enters the anodal chamber as a heated carrier gas per hour. The 6000 lbs of heated carrier gas flowing into the anodal stabilization chamber has been internally reacted with one pound (1 lb) of sodium which has been divided into 126 mg which has been hydrolyzed and mixed with the heated CO₂ carrier gas stream forming positive charged univalent aldehydes (CO₂H⁺) within CO₂ molecular gas interstice. The electrons (e⁻) formed in the hydrolyzed components of the reaction enter the anodal stabilization chamber 5 though electrical conduit 18 pass into electromagnetic coil 19 and are grounded to the aspirator jet assembly 14 which is in turn is attached in electrical communication with the anode electrode assembly 9 causing the anode plates 6 of the said assembly to be strongly negatively charged. Aspirator jet assembly 14, aspiration water 27 passing through metering valve 15, aspirates the positive charged univalent aldehyde (CO₂H⁺) element 12 between the said negative charged plates 6 of anode electrode assembly 9. The hydrogen ion concentration is increased in the diffuse heated CO₂ carrier gas 12 mixture passing between negative charged plates 6 of the anode electrode assembly 9. Acidification of aspiration water 27 when nitrile products or ammonia needing more hydrogen in the terminal tertiary carbon at the product chopping frequency is required. The water moisture from expended carrier gases 25 is aspirated by aspirator jet assembly 14 through orifices 8 into aspiration tube 10 and recirculated through aspirator jet assembly 14. The remainder of the expended carrier gas not recirculated falls to the bottom of the anodal stabilization chamber 5 and passes out as a fluid mixture product 22 through flange 29 at the bottom of anodal chamber 5 and undergoes further processing. The oxygen 23 passes out of the top anodal chamber 5 through flange 28.

What is claimed is:

1. An anodal stabilization chamber having a centrally located anode electrode assembly comprising a plurality of anode plates perpendicularly spaced and axially aligned at regular spaced fixed intervals about an aspiration tube having a plurality of orifices radially spaced at even intervals between the said plates, an aspirator jet assembly fixedly attached to the upper end of the aspirator tube for aspirating a CO₂ carrier stream and protons through a flange into the anodal chamber and passing between the said anode plates and ejected through an aspiration discharge nozzle, an electromagnetic field coil encompassing the outer surfaces of the aspirator discharge nozzle, a modular chopping coil encompassing the electromagnetic field coil, a metering valve controlling the aspiration water, ultrasonic transducers attached to the outer surfaces of the anodal chamber, the expanded discharge of expended carrier gas product passing out of anodal stabilization through a flange at the bottom of the anodal stabilization chamber.

2. Claim 1 in which the water entering the metering valve is acidified.

3-4. (canceled)

5. An anodal stabilization chamber having a centrally located anode electrode assembly comprising a plurality of anode plates perpendicularly spaced and axially aligned at regular spaced fixed intervals forming an aspiration tube having a plurality of orifices radially spaced at even intervals between the said plates, an aspirator jet assembly fixedly attached to the upper end of the aspirator tube for aspirating a CO₂ carrier stream and protons through a flange into the anodal chamber and passing between the said anode plates and ejected through an aspiration discharge nozzle, an electromagnetic field coil encompassing the outer surfaces of the aspirator discharge nozzle, a modular chopping coil encompassing the electromagnetic field coil, a metering valve controlling the aspiration water, ultrasonic transducers attached to the outer surfaces of the anodal chamber, the expanded discharge of expended carrier gas product passing out of anodal stabilization chamber through a flange at the bottom of the anodal stabilization chamber.

6. Claim 5 in which the water entering the metering valve is acidified.
